(19) United States
(12) Patent Application Publication
(10) Pub. No.: US 2024/0403852 A1
(43) Pub. Date: Dec. 5, 2024

(54) SECURE TRANSACTION NOTIFICATIONS

(71) Applicant: Cherry Net, Inc., Brooklyn, NY (US)

(72) Inventors: Moshe B. Teitelbaum, Brooklyn, NY (US); Zelig Rosenthal, Brooklyn, NY (US)

(21) Appl. No.: 18/427,749

(22) Filed: Jan. 30, 2024

Related U.S. Application Data
(60) Provisional application No. 63/441,988, filed on Jan. 30, 2023.

(51) Int. Cl. G06Q 20/20; G06Q 30/0601

(52) U.S. Cl. CPC G06Q 20/209; G06Q 30/0641

(57) ABSTRACT

Systems and methods are disclosed for secure transaction notifications. In one implementation, a first transaction record generated by a first device with respect to a second device is received. The received first transaction record is processed in conjunction with a transaction execution application executing on the second device. One or more notifications corresponding to the processing of the first transaction record in conjunction with the second device are received. One or more operations are initiated with respect to the first device based on at least one of the one or more notifications.

### CROSS-REFERENCE TO RELATED APPLICATION

This application is related to and claims the benefit of priority to U.S. patent application Ser. No. 63/441,988, filed Jan. 30, 2023, which is incorporated herein by reference in its entirety.

### TECHNICAL FIELD

Aspects and implementations of the present disclosure relate to data processing and, more specifically, but without limitation, to secure transaction notifications.

### BACKGROUND

Existing transaction frameworks can enable users to initiate transactions between one account and another.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system, in accordance with an example embodiment.

FIG. 2 illustrates aspects of the features, functions, and operations of an example system, in accordance with an example embodiment.

FIG. 3 illustrates further aspects of the features, functions, and operations of an example system, in accordance with an example embodiment.

FIG. 4 is a flow chart illustrating aspects of a method for secure transaction notifications, in accordance with an example embodiment.

FIG. 5 is a block diagram illustrating components of a machine able to read instructions from a machine-readable medium and perform any of the methodologies discussed herein, according to an example embodiment.

### DETAILED DESCRIPTION

Aspects and implementations of the present disclosure are directed to secure transaction notifications.

Numerous systems touch various aspects of routine commercial activity (e.g., accounting systems, banking systems, inventory management systems, shipping and delivery management systems, shipping companies, etc.). While some systems can be configured to interface with one another in limited ways, few if any provide transparency with respect to intermediate operations, such as those that occur internally within an organization. Additionally, the lack of compatibility and interoperability between systems used across different organizations results in significant confusion and requires substantial efforts to reconcile records reflected in one system with those maintained in another. By way of illustration, accounting systems maintained independently by different organizations often contain much of the same information (e.g., an invoice generated by one system is ultimately processed for payment within another system). Yet such independent systems often store such information in discrete ways, precluding interoperability and introducing human error and inefficiencies when such records must be reconciled.

Moreover, in certain scenarios a transaction request (e.g., an invoice sent by one party seeking payment from another party for goods, services, etc.) can be questioned, disputed, challenged, etc. By way of illustration, a customer may seek to pay for a portion of an invoice while withholding payment on another portion. In other scenarios, a customer may transmit a single payment that is intended to cover multiple invoices (and/or portions thereof). Existing technologies cannot readily enable a customer to designate how such payment(s) should be allocated. Additionally, upon receiving such payments, the vendor's system(s) are generally incapable of reconciling how such payments should be allocated (e.g., to reflect invoices and/or portions thereof that the customer intends should remain outstanding). And in scenarios in which subsequent adjustments or corrections are made (e.g., to a previously issued invoice), such a process is generally ‘manual,’ which can result in multiple invoices for the same products, services, etc., causing yet further potential confusion and inefficiencies.

Accordingly, described herein in various implementations are technologies that enable secure transaction notifications and other related operations. Using the described technologies, numerous discrete systems and computing environments can generate and exchange notifications, updates, and other such content. Such notifications can reflect, for example, operations or occurrences initiated with respect to a specific transaction record (e.g., an invoice), such as the review of such an invoice or its internal approval for payment. By generating and providing such notifications, the described technologies provide additional transparency with respect to the processing of such transactions and can further enable implementation of additional operations and/or capabilities based on them, as described herein.

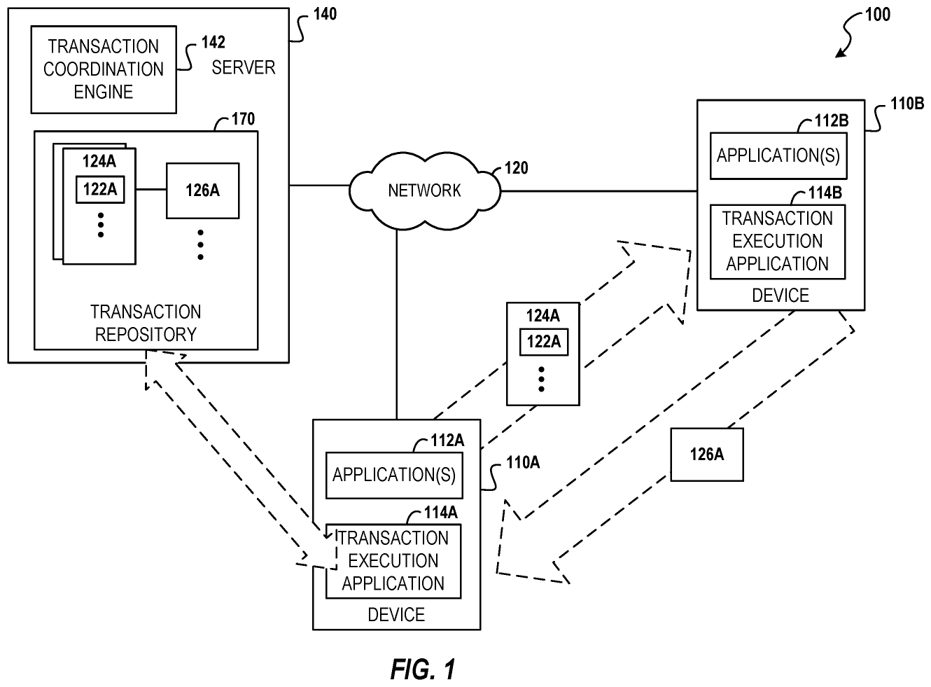

FIG. 1 illustrates an example system 100, in accordance with some implementations. As shown, system 100 includes components such as device 110A and device 110B (collectively, devices 110). Each of the referenced devices 110 can be, for example, a laptop computer, a desktop computer, a smartphone, a mobile phone, a terminal, a tablet computer, a smart watch, a wearable device, a connected device, a speaker device, a server, and the like. Human users can interact with respective device(s) 110. For example, a user can provide various inputs (e.g., via an input device/interface such as a keyboard, mouse, touchscreen, microphone, etc.) to device(s) 110A. Device(s) 110 can also display, project, and/or otherwise provide content to the user (e.g., via output components such as a screen, speaker, etc.).

As shown in FIG. 1, device(s) 110 can include one or more application(s) 112. Such applications can be programs, modules, or other executable instructions that configure/enable the device to interact with, provide content to, and/or otherwise perform operations on behalf of a user. Examples of such applications include but are not limited to internet browsers, mobile apps, ecommerce applications, social media applications, personal assistant applications, games, etc.

By way of further illustration, application(s) 112 can include mobile apps that enable users to initiate various transactions and/or other operations with third party services, such as banking services, food delivery services, ride sharing services, ecommerce services, websites, platforms, etc. By way of yet further illustration, application(s) 112 can include accounting applications, such as those that enable users to track incoming and outgoing payments, transactions, invoices, etc. Other examples of such applications can include those utilized in connection with an enterprise resource planning (ERP) system (such as those that enable users to plan, forecast, mange or track digital/physical inventory, goods, or other resources), a point of sale (POS) system (such as those that enable users to perform retail transactions and mange retail inventory and resources), and/or other such applications.

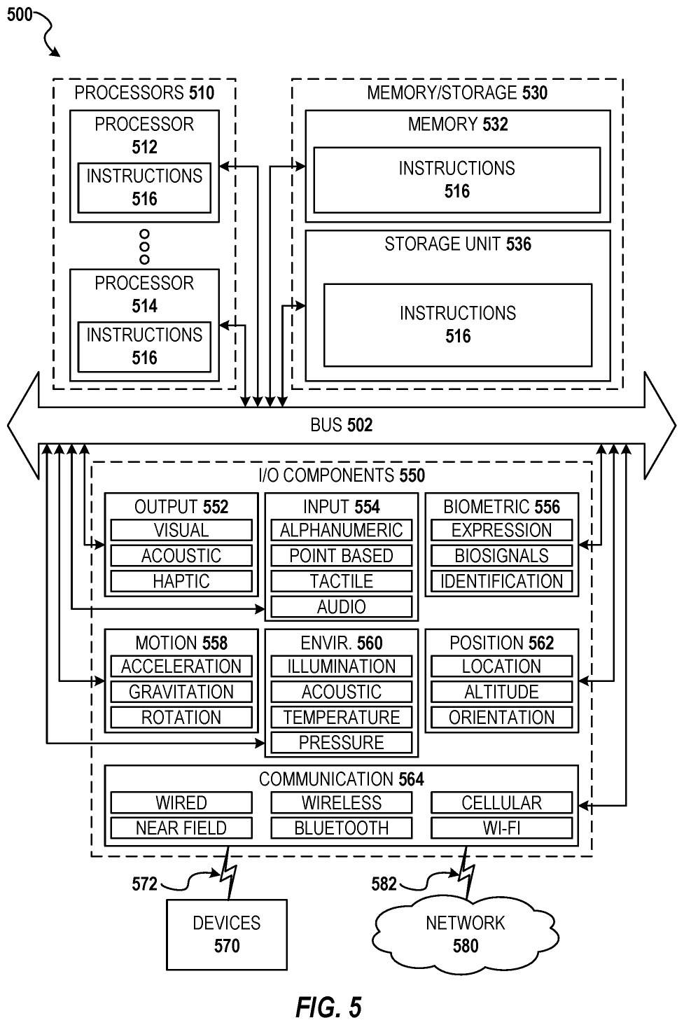

Application(s) 112 can be stored in memory of device 110 (e.g., memory 530 as depicted in FIG. 5 and described below). One or more processor(s) of device 110 (e.g., processors 510 as depicted in FIG. 5 and described below) can execute such application(s). In doing so, device 110 can be configured to perform various operations, present content to a user, etc.

In certain implementations, device 110 can also include transaction execution application 114. Transaction execution application 114 can include, for example, programs, modules, or other executable instructions that configure/enable the device to initiate/execute transactions in relation to other device(s), machines, systems, services, etc., such as device(s) 110, server 140, services 150, etc. In other implementations, transaction execution application 114 can be a plugin application that executes on device 110, e.g., in conjunction with application(s) 112, in order to configure such application(s) (e.g., accounting applications) to perform the operations described herein. Additionally, in certain implementations transaction execution application 114 can be configured to generate and/or modify or adjust aspects of various transaction records, and/or perform other operations, as described herein.

It should be noted that while application(s) 112 and 114 are depicted and/or described as operating on a device 110, this is only for the sake of clarity. However, in other implementations such elements can also be implemented on other devices/machines. For example, in lieu of executing locally at device 110, aspects of application(s) 112 can be implemented remotely (e.g., on a server device or within a cloud service or framework).

As also shown in FIG. 1, device 110A can connect to and/or otherwise communicate with other device(s) 110B, server 140, and other machines, devices, systems, services, etc. via network 120. Network 120 can include one or more networks such as the Internet, a wide area network (WAN), a local area network (LAN), a virtual private network (VPN), an intranet, and the like.

Server 140 can be, for example, a server computer, computing device, storage service (e.g., a ‘cloud’ service), etc. that enables operations including the coordination and execution of transactions between parties, as described herein. In certain implementations, server 140 can include transaction coordination engine 142.

Transaction coordination engine 142 can be an application, module, instructions, etc., that configures/enables the server to perform various operations described herein. In certain implementations, transaction coordination engine 142 can coordinate the exchange of notifications or updates (e.g., transaction-related notifications), securely and verifiably coordinate transactions and other operations between parties and institutions, and/or perform other operations such as those described herein. These and other described features, as implemented with respect to server 140 and/or one or more particular machine(s), can improve the functioning of such machine(s) and/or otherwise enhance numerous technologies including enabling and enhancing the security, execution, and efficiency of various operations, as described herein.

As used herein, the term “configured” encompasses its plain and ordinary meaning. In one example, a machine is configured to carry out a method by having software code for that method stored in a memory that is accessible to the processor(s) of the machine. The processor(s) access the memory to implement the method. In another example, the instructions for carrying out the method are hard-wired into the processor(s). In yet another example, a portion of the instructions are hard-wired, and a portion of the instructions are stored as software code in the memory.

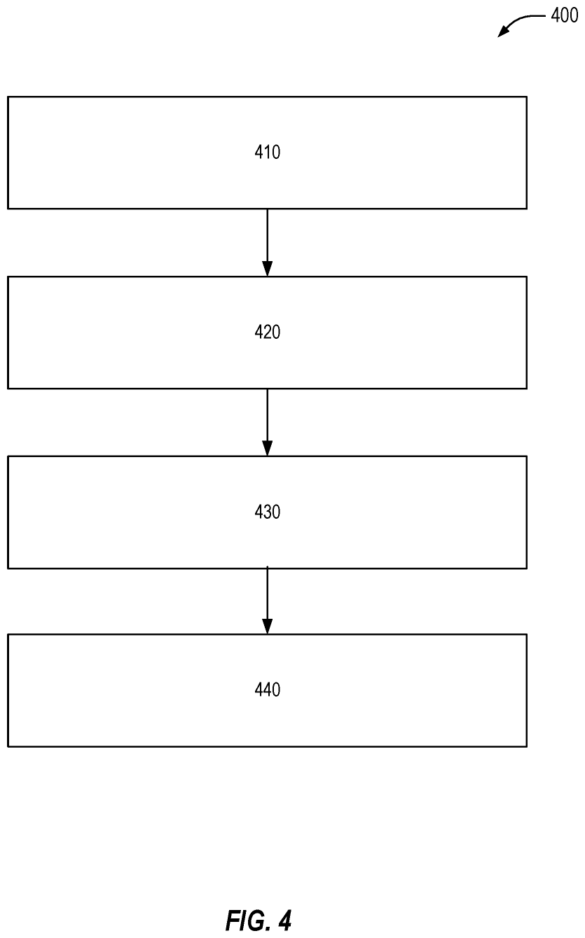

In certain implementations, various aspects of the described technologies include methods performed by processing logic that can comprise hardware (circuitry, dedicated logic, etc.), software (such as is run on a computing device such as those described herein), or a combination of both. For example, FIG. 4 is a flow chart illustrating a method 400, according to an example embodiment, for secure transaction notifications. Such method(s) can be performed by processing logic that can comprise hardware (circuitry, dedicated logic, etc.), software (such as is run on a computing device such as those described herein), or a combination of both. In one implementation, such method(s) are performed by one or more elements depicted and/or described in relation to FIG. 1 (including but not limited to server 140, one or more applications or modules executing thereon, and/or device(s) 110), while in some other implementations, the one or more operations can be performed by another machine or machines.

For simplicity of explanation, methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

In certain implementations, transaction coordination engine 142 can generate and maintain repositories, such as transaction repository 170. Such repositories can be further utilized to enable the coordinated exchange of transaction-related notifications and/or their association with transaction record(s), as described herein.

Transaction repository 170 can be a storage resource such as an object-oriented database, a relational database, a decentralized or distributed ledger (e.g., blockchain), etc. In certain implementations, transaction repository 170 can maintain various transaction record(s) (e.g., transaction record 124A, as shown). Such transaction records can be data structures or other such content or information that include or reflect aspects of a transaction (e.g., a purchase/sale of goods between two entities).

As shown in FIG. 1 and described herein, such transaction records can further include information such as the item(s) being purchased, as well as the quantity, amount, costs, etc. (e.g., as reflected in a purchase order, invoice, etc.). For example, an entity seeking to purchase a product can transmit a purchase order identifying the item, quantity, price, etc., in response to which a selling entity can transmit an invoice containing related (though, under some circumstances, different or updated) information from that contained or reflected in an initial purchase order.

Additionally, in certain implementations transaction repository 170 can include or incorporate a ledger of various notifications or status updates 126. Such notification(s) 126 can reflect, for example, operations or occurrences, etc., initiated with respect to the referenced transaction record(s). Such operations (which are reflected in the referenced notifications) can be those associated with aspects of the processing of purchase orders, invoices, etc., as described herein.

By way of further illustration, it can be appreciated that upon receipt of an invoice, an entity (e.g., a purchaser to whom the invoice is directed) may undertake various internal procedures or operations prior to initiating and/or executing payment for the invoice. For example, various individuals may need to review and/or approve the invoice before payment is sent. By way of further example, in certain scenarios an invoice (or portions thereof) may be approved for payment, but such payment may not be initiated for some period of time (e.g., days or weeks) later. Accordingly, as described herein, the described technologies enable notification(s) or update(s) to be generated and/or provided (corresponding to such operations). In doing so, various entities (including the seller that issued the invoice and/or various third parties) can be provided additional transparency with respect to the processing of the referenced invoice. Additionally, various additional operations and/or capabilities can be implemented (based on the providing of the referenced notifications/updates), as described herein.

As shown in FIG. 1, in one example scenario device 110A can correspond to a ‘seller’ entity seeking to invoice another entity (110B) for the purchase of goods. In certain implementations, device 110A can generate and/or transmit a first transaction record 124A. For example, application(s) 112A (e.g., an accounting application) can generate an invoice (transaction record 124A). Such a transaction record 124A can include parameters or values 122 reflecting, for example, the item(s) the purchaser purchased, the quantity purchased, and the price the purchaser is to pay. As shown in FIG. 1, in certain implementations device 110A (e.g., a seller) can send or transmit the generated transaction record 124A to device 110B (e.g., the purchaser).

Moreover, in certain implementations transaction execution application 114A can also provide first transaction record 124A (e.g., the referenced invoice) to server 140 (and can be received, e.g., by server 140 and/or transaction coordination engine 142) (operation 410). Such a first transaction record 124A can be further stored in transaction repository 170, as shown in FIG. 1.

While many of the examples described herein are illustrated with respect to multiple machines 110, 140, etc., this is simply for the sake of clarity and brevity. However, it should be understood that the described technologies can also be implemented (in any number of configurations) with respect to a single computing device/service.

As shown in FIG. 1, transaction record 124A (e.g., the referenced invoice) can be transmitted (e.g., by device 110A) to device 110B (e.g., a device corresponding to the purchaser). In certain implementations, transaction execution application 114A (as executing on device 110A) can coordinate aspects of the transmission of such a transaction record. In one example implementation, transaction execution application 114A can be a plug-in (or freestanding application) that operates in conjunction with application(s) 112A (e.g., an accounting application).

Upon receiving the referenced transaction record 124A, transaction execution application 114B can process such a record (e.g., an invoice) in various ways. In doing so, transaction execution application 114B can, for example, parse the data/content originating from the vendor application(s) 112A to ensure it is consistent with aspect(s) of the configuration of the device 110B, such as the nomenclature, naming conventions, formatting, and/or other parameters used by the purchaser (and/or various systems or services utilized by the purchaser).

As also shown in FIG. 1, in certain implementations transaction execution application 114B can operate in conjunction with transaction coordination engine 142 and/or other elements or components of server 140 (420). For example, server 140 and transaction coordination engine 142 can operate to initiate, create, and/or implement related operations or other transactions, e.g., based on aspects of the status, processing, etc., of transaction records (e.g., invoices, etc.), as described herein.

Moreover, in certain implementations transaction execution application 114B can generate various notifications, status update(s), etc., e.g., in connection with the processing of the referenced transaction record 124 (e.g., an invoice). Such notifications or updates can reflect various operations that may be performed with respect to the received transaction record 124A (e.g., an invoice received from vendor 110A, to be processed by purchaser 110B).

For example, upon receiving the referenced transaction record (e.g., an invoice), purchaser 110B may process the invoice internally, e.g., by forwarding it to various personnel for review and/or approval, queuing the invoice for processing (e.g., for payment via a third-party institution such as a bank), and/or other such operations. In certain implementations, transaction execution application 114B can generate various notification(s) or update(s) 126 that reflect such operations (e.g., the routing of an invoice for approval, the approval of an invoice for payment, the transmission of instructions to pay an invoice, etc.), as described herein.

In certain implementations, the referenced notification(s) or update(s) 126 (and/or elements thereof) can be transmitted (and/or received, e.g., by server 140) (430). For example, as shown in FIG. 1, device 110B (corresponding to a purchaser who received transaction record 124A—e.g., an invoice—from device 110A, corresponding to a seller) can transmit notification 126A to device 110A. Such a notification or update can reflect, for example, that transaction record 124A (e.g., the invoice) has been routed to various individuals for approval, processing, etc. By way of further example, the referenced notification or update can reflect that transaction record 124A (e.g., an invoice) has been approved for payment, instructed for payment, etc.

Additionally, in certain implementations the referenced notification(s) can include or incorporate various selectable prompts or options. In one example scenario, such a prompt can ask a reviewer to approve payment for an invoice (or portion thereof). In another example scenario, such notification(s) can log and/or otherwise memorialize that an invoice has been routed to and/or accessed or reviewed by a given individual. For example, in certain implementations the described technologies can be configured to only initiate certain transactions, payments, etc., upon review and/or approval of an invoice by a designated individual, administrator, etc.

As shown in FIG. 1, one or more operations can be initiated with respect to the referenced notification or update 126, such as transmitting the referenced notification or update to device 110A (corresponding to the vendor associated with the invoice) and/or server 140 (440). Doing so can provide additional security and transparency with respect to the processing of the invoice and enable other operations and services to utilize or leverage this status, such as is described herein. As also shown in FIG. 1. The referenced notification or update 126 can also be stored in transaction repository 170, e.g., in association with transaction record 124A (e.g., the corresponding invoice).

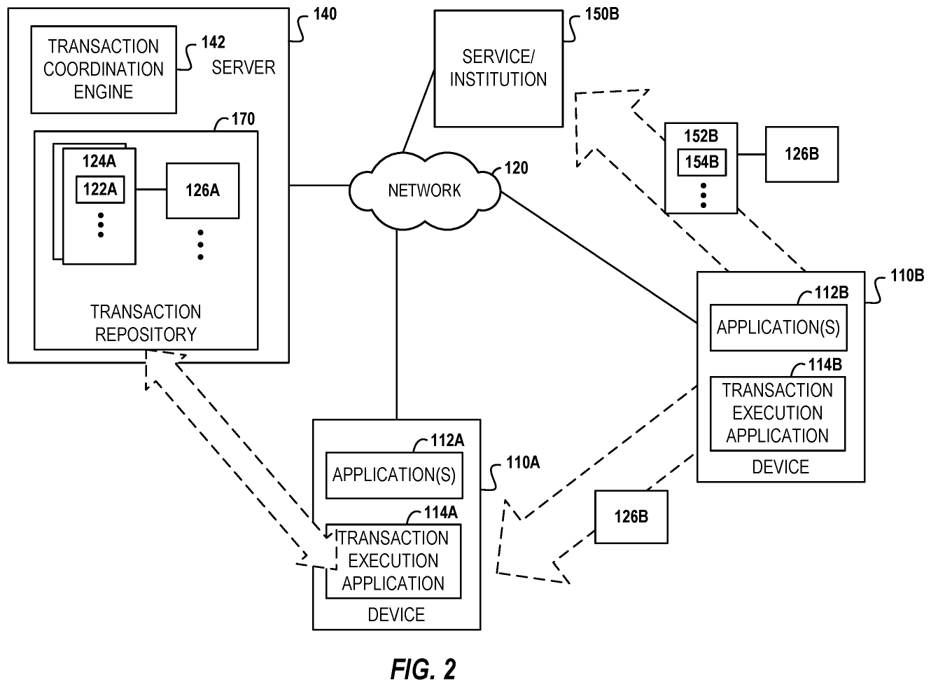

FIG. 2 depicts further aspects of the processing of the described transaction and/or related operations. As shown in FIG. 2, in connection with the processing of the referenced transaction record 124A (e.g., an invoice received by purchaser 110B from vendor 110A), the purchaser can initiate various operation(s). As noted, such operations can include the routing, review, and approval for payment of the referenced invoice (and/or portions thereof). As noted, the described technologies (e.g., transaction execution application 114B, executing on device 110B) can generate notifications or updates 126 reflecting such operations.

For example, as shown in FIG. 2, in certain implementations device 110B (e.g., corresponding to a purchaser) can transmit an instruction to a financial institution (e.g., a bank) directing that a transaction (e.g., a payment) be made. By way of illustration, after receiving an invoice, routing the invoice for review and approval, and receiving the necessary approval(s), the invoice can be approved for payment.

For example, application(s) 112B executing on device 110B (e.g., an accounting application used by the purchaser of the goods) can transmit instructions to institution 150B (e.g., a bank or payment service associated with the purchaser) to initiate payment to a vendor (e.g., at a future date and/or for a specific invoice or portion thereof). In certain implementations, transaction execution application 114B (e.g., a plugin application executing on device 110B in conjunction with application(s) 112B) can coordinate the generating of a transaction record 152B corresponding to such a payment instruction.

As noted, service/institution 150B can be for example, a financial institution, ecommerce website, credit/debit card platform, or other such third-party services with respect to which entities or individuals may maintain accounts. Such accounts can be associated with account numbers, routing numbers, credit/debit card numbers, addresses associated with digital assets (e.g., Bitcoin, Ethereum, and/or other such digital assets that may be stored and/or transacted within distributed or decentralized networks), and/or other such account identifiers which can be used, for example, to enable one entity to initiate a payment or other such transaction or operation to another entity. In certain implementations, such transactions can be executed via various payment networks (e.g., ACH, RTP, debit/credit card, wire, etc.) that enable transactions between the respective accounts each user maintains with the respective institution(s).

It should also be understood that, in certain implementations, the referenced transaction record 152 (which corresponds to a payment instruction originating from a purchaser) can include parameters 154. Such parameters can, for example, identify the institution and account from which the payment originates, the institution and account to which the payment is directed, the payment amount, and other information corresponding to a financial transaction.

As also shown in FIG. 2, the described notification or update 126B can be further associated with transaction record 152. Such an update can further reflect, for example, the date/time at which the payment (or another such operation) is to be initiated or executed. Associating notification 126 to transaction record 152 can create an audit trail and provides further context to the referenced financial transaction, and enables validation, confirmation, and authentication of the underlying transaction (in lieu of a transfer of funds between two accounts with little additional context or information), as described herein.

Moreover, in certain implementations the referenced notification 126 can correspond to or reflect specific items, or amounts contained within an invoice. For example, in certain scenarios a purchaser may send payment for only a portion of the items or amounts listed on an invoice. In other scenarios, a purchaser may receive multiple invoices from a vendor and send a single payment corresponding to the aggregate amount of multiple invoices (and/or portions thereof); Accordingly, the described technologies can generate and provide notification(s) 126 that reflect the items or amounts that the payment sent is intended to correspond to (e.g., the specific items on a given invoice, the specific invoices, etc.). In doing so, the vendor can more accurately and efficiently reconcile such payment upon receipt, as described herein.

Additionally, in certain implementations, the described technologies can be configured to generate and/or transmit certain notification(s) 126 that reflect that an invoice (and/or portion thereof) is being questioned, disputed, challenged, etc. (e.g., by customer). In one example scenario, a customer can designate a payment to be allocated towards an item/portion of an invoice, and/or designate that a payment is not to be applied towards another item/portion. Corresponding notification(s) 126 can be generated and transmitted (e.g., to the vendor from whom the invoice originated). Based on such notification(s), such a vendor can process the referenced payment(s) such that they are properly attributed to the item(s) to which the customer intended them to by applied to (and not attributed to items the customer did not intend such payments to be attributed to). Doing so can increase efficiency, e.g., in the processing and reconciliation of transactions, payments, etc.

In another example scenario, the described technologies can be configured to generate and/or transmit certain notification(s) 126 that reflect that a payment originating from a customer is intended to be applied to multiple invoices (and/or portions thereof), such as those originating from a single vendor. In one example scenario, a customer can designate a payment to be allocated towards multiple invoice(s), and/or designate that a payment is not to be applied towards other invoice(s). Corresponding notification(s) 126 can be generated and transmitted (e.g., to the vendor from whom the invoice(s) originated). Based on such notification(s), the referenced vendor can process the referenced payment(s) such that they are properly attributed to the invoice(s) to which the customer intended them to by applied to (and not attributed to invoices the customer did not intend such payments to be attributed to). Doing so can increase efficiency, e.g., in the processing and reconciliation of transactions, payments, etc.

Moreover, in related scenarios, the described technologies can be further configured to generate/transmit notification(s) 126 corresponding to various inquiries, disputes, etc. that may arise with respect to the processing of such invoice(s), as well as the resolution of such disputes. For example, a customer receiving an invoice from a vendor on which one or more items are (in the customer's view) subject to dispute can select or ‘flag’ such disputed item(s) (e.g., in an accounting application. Doing so can generate corresponding notification(s) which can be transmitted/relayed to the vendor (e.g., as described herein). Such notification(s) can, for example, document the customer's basis for disputing the item and/or other related information (e.g., timestamp, user initiating the dispute, evidence the user attaches, etc.). The vendor can review and respond to such notification(s), e.g., by generating additional corresponding notifications (which, for example, respond to the issues raised by the customer, provide further evidence, etc.). In doing so, an audit trail can be generated, memorializing the manner in which inquiries, disputes, etc., have been initiated and communicated.

The referenced notifications can also incorporate selectable prompts or options that can memorialize resolution of such dispute(s). By way of illustration, a notification reflecting a dispute initiated by a customer can be presented to the vendor with selectable option(s) including: cancel/remove disputed entry, adjust disputed entry, provide clarification/explanation, etc. Dispute-related notifications presented to a customer can include: accept proposed adjustment, accept provided clarification/explanation, escalate dispute, etc. In doing so, the described technologies can facilitate the resolution of disputes (such as those which pertain to only a portion of an invoice) while maintaining an audit trail memorializing the actions and positions of each party. In other example scenarios, such prompt(s) can enable a vendor to cancel or reissue an invoice, re-route an invoice (e.g., to another entity) and/or take various other actions such as those described herein.

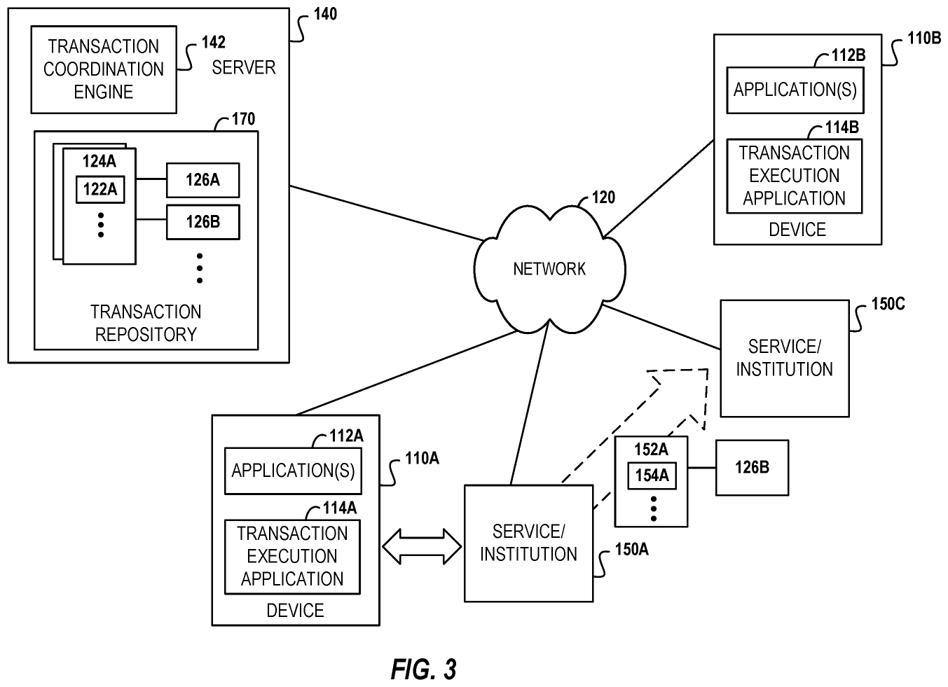

FIG. 3 depicts further aspects in which the described transaction notifications 126 can be utilized to facilitate additional operations. As described herein (e.g., with respect to FIG. 2), the disclosed technologies can generate and provide notifications or updates that can correspond to intermediate steps or operations prior to, concurrent with, and/or subsequent to the ultimate execution of payment, e.g., for an invoice. Such notifications, updates, etc., can reflect a likelihood that the referenced payment is to be executed (e.g., by a given date). Accordingly, as described herein, the disclosed technologies can further utilize such notifications or updates to enable the anticipated recipient of such funds to leverage them (e.g., with respect to subsequent transactions or other operations).

For example, as shown in FIG. 3, transaction repository 170 incorporates notification 126B which reflects that a payment (originating from purchaser 110B) has been approved or queued. Such a notification 126B can be associated with transaction record 124A (e.g., an invoice sent by the seller 110A), as shown. It can be appreciated that in such a scenario, seller 110A can be determined to be likely to receive the corresponding funds by a date certain. Accordingly, in certain implementations the described technologies can enable seller 110A to leverage the anticipated payment of such funds (as reflected in notification 126B) to initiate additional transactions or other such operations. For example, as shown in FIG. 3, seller 110A can initiate a transaction 152A (via service/institution 150A, e.g., a financial institution, ecommerce website, credit/debit card platform, or other such third-party services with respect to which seller 110A may maintain an account). As shown in FIG. 3, such a transaction can be associated with notification 126B (that is, the anticipated payment initiated by purchaser 110B). In doing so, vendor 110A can leverage the referenced funds based on a notification that such funds have been approved for payment (but prior to such payment being executed).

In another example implementation, the described technologies can be further configured to enable subsequent transactions that are contingent on the execution or completion of prior transactions. For example, in the scenario described above, by associating notification 126B to transaction 152A (e.g., a transaction initiated by vendor 110A), such a transaction can be configured to only execute upon confirmation that the underlying transaction (upon which it is based) has been completed.

Implementing the described technologies can also provide additional technical advantages and improvements in other contexts. For example, in certain implementations the referenced notifications or updates can reflect that a specific payment, transaction, etc., corresponds to a subset or portion of the items or amounts listed on an invoice. In such a scenario, implementing the described notifications or updates can enable a vendor (from whom the invoice originated) to reconcile the payment received with the portion of the outstanding invoice to which the payment is directed.

The described technologies can also provide technical advantages and improvements in other reconciliation applications and contexts. For example, in a scenario in which a purchaser transmits a single payment corresponding to multiple underlying invoices (and/or portions thereof), the described technologies can generate and provide notification(s) 126 reflecting the items or amounts that the payment sent is intended to correspond to (e.g., the specific items on a given invoice, the specific invoices, etc.). Based on such notification(s), the vendor can more accurately and efficiently reconcile such payment upon receipt (e.g., by attributing it to the items/invoices to which it was intended).

The described technologies can further enable various technical advantages and efficiencies in scenarios in which item(s) owned by one party are stored and/or offered for sale by another party (e.g., on a consignment basis). In such scenarios, the described technologies can enable underlying reporting, reconciliation, and other associated operations and transactions to be performed automatically and/or in real time.

By way of further illustration, the described technologies can further implement operations, transactions, etc., initiated based on the described notifications 126 in connection with inputs or updates originating from other sources, sensors, etc. By way of illustration, various tracking/logistics technologies (e.g., sensors such as GPS, NFC, Bluetooth, etc.) can be integrated to track shipments, delivery status, etc. of an item. Accordingly, upon determining, for example, that a product, shipment, etc., has been dispatched (e.g., from a warehouse), the described technologies can initiate a notification that payment for such an item has been approved, processed, etc. In doing so, the described technologies can enable transactions to be initiated (and providing transparency regarding the processing of such transactions) in scenarios in which inventory for an item may be undetermined at the time of purchase (such that the purchaser may wish to withhold processing or approval for payment until a determination that the product can be or is shipped is received). Additionally, in certain implementations the described technologies can maintain information originating from such tracking/logistics technologies (e.g., GPS, NFC, other sensors or data sources, etc.) in association with the described transaction record(s) (e.g., within transaction repository 170). Doing so can further enable tracking of inventory along a supply chain (e.g., from a manufacturer to a wholesaler to a retailer to a consumer), and enable further operations based on such association(s), as described herein.

It should also be understood that, in certain implementations, various aspects of the operations described herein with respect to a single machine (e.g., server 140) can be implemented with respect to multiple machines. For example, in certain implementations repository 170 can be implemented as an independent server, machine, service, etc.

It can also be appreciated that the described technologies provide numerous technical advantages and improvements over existing technologies. For example, the described technologies can enable and automate the secure and verifiable execution of the referenced transactions and/or other operations using existing accounts, services, institutions, transaction frameworks/protocols, etc., while also providing enhanced functionality, security, and efficiency, as described herein.

It can therefore be appreciated that the described technologies are directed to and address specific technical challenges and longstanding deficiencies in multiple technical areas, including but not limited to transaction authentication, transaction processing, and secure operations. As described in detail herein, the disclosed technologies provide specific, technical solutions to the referenced technical challenges and unmet needs in the referenced technical fields and provide numerous advantages and improvements upon conventional approaches. Additionally, in various implementations one or more of the hardware elements, components, etc., referenced herein operate to enable, improve, and/or enhance the described technologies, such as in a manner described herein.

It should be understood that the examples provided herein are intended only for purposes of illustration and any number of other implementations are also contemplated. Additionally, the referenced examples (including the described rules and/or other techniques) can be combined in any number of ways.

It should also be noted that while the technologies described herein are illustrated primarily with respect to secure transaction notifications, the described technologies can also be implemented in any number of additional or alternative settings or contexts and towards any number of additional objectives.

Certain implementations are described herein as including logic or a number of components, modules, or mechanisms. Modules can constitute either software modules (e.g., code embodied on a machine-readable medium) or hardware modules. A “hardware module” is a tangible unit capable of performing certain operations and can be configured or arranged in a certain physical manner. In various example implementations, one or more computer systems (e.g., a standalone computer system, a client computer system, or a server computer system) or one or more hardware modules of a computer system (e.g., a processor or a group of processors) can be configured by software (e.g., an application or application portion) as a hardware module that operates to perform certain operations as described herein.

In some implementations, a hardware module can be implemented mechanically, electronically, or any suitable combination thereof. For example, a hardware module can include dedicated circuitry or logic that is permanently configured to perform certain operations. For example, a hardware module can be a special-purpose processor, such as a Field-Programmable Gate Array (FPGA) or an Application Specific Integrated Circuit (ASIC). A hardware module can also include programmable logic or circuitry that is temporarily configured by software to perform certain operations. For example, a hardware module can include software executed by a programmable processor. Once configured by such software, hardware modules become specific machines (or specific components of a machine) uniquely tailored to perform the configured functions. It will be appreciated that the decision to implement a hardware module mechanically, in dedicated and permanently configured circuitry, or in temporarily configured circuitry (e.g., configured by software) can be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering implementations in which hardware modules are temporarily configured (e.g., programmed), each of the hardware modules need not be configured or instantiated at any one instance in time. For example, where a hardware module comprises a processor configured by software to become a special-purpose processor, the processor can be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In implementations in which multiple hardware modules are configured or instantiated at different times, communications between such hardware modules can be achieved, for example, through the storage and retrieval of information in memory structures to which the multiple hardware modules have access. For example, one hardware module can perform an operation and store the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors can constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors can also operate to support performance of the relevant operations in a “cloud computing” environment or as a “software as a service” (SaaS). For example, at least some of the operations can be performed by a group of computers (as examples of machines including processors), with these operations being accessible via a network (e.g., the Internet) and via one or more appropriate interfaces (e.g., an API).

The performance of certain of the operations can be distributed among the processors, not only residing within a single machine, but deployed across a number of machines. In some example implementations, the processors or processor-implemented modules can be located in a single geographic location (e.g., within a home environment, an office environment, or a server farm). In other example implementations, the processors or processor-implemented modules can be distributed across a number of geographic locations.

The modules, methods, applications, and so forth described in conjunction with FIGS. 1-3 are implemented in some implementations in the context of a machine and an associated software architecture. The sections below describe representative software architecture(s) and machine (e.g., hardware) architecture(s) that are suitable for use with the disclosed implementations.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture can yield a smart device for use in the “internet of things,” while yet another combination produces a server computer for use within a cloud computing architecture. Not all combinations of such software and hardware architectures are presented here, as those of skill in the art can readily understand how to implement the inventive subject matter in different contexts from the disclosure contained herein.

FIG. 5 is a block diagram illustrating components of a machine 500, according to some example implementations, able to read instructions from a machine-readable medium (e.g., a machine-readable storage medium) and perform any one or more of the methodologies discussed herein. Specifically, FIG. 5 shows a diagrammatic representation of the machine 500 in the example form of a computer system, within which instructions 516 (e.g., software, a program, an application, an applet, an app, or other executable code) for causing the machine 500 to perform any one or more of the methodologies discussed herein can be executed. The instructions 516 transform the non-programmed machine into a particular machine programmed to carry out the described and illustrated functions in the manner described. In alternative implementations, the machine 500 operates as a standalone device or can be coupled (e.g., networked) to other machines. In a networked deployment, the machine 500 can operate in the capacity of a server machine or a client machine in a server-client network environment, or as a peer machine in a peer-to-peer (or distributed) network environment. The machine 500 can comprise, but not be limited to, a server computer, a client computer, PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 516, sequentially or otherwise, that specify actions to be taken by the machine 500. Further, while only a single machine 500 is illustrated, the term “machine” shall also be taken to include a collection of machines 500 that individually or jointly execute the instructions 516 to perform any one or more of the methodologies discussed herein.

The machine 500 can include processors 510, memory/storage 530, and I/O components 550, which can be configured to communicate with each other such as via a bus 502. In an example implementation, the processors 510 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) can include, for example, a processor 512 and a processor 514 that can execute the instructions 516. The term “processor” is intended to include multi-core processors that can comprise two or more independent processors (sometimes referred to as “cores”) that can execute instructions contemporaneously. Although FIG. 5 shows multiple processors 510, the machine 500 can include a single processor with a single core, a single processor with multiple cores (e.g., a multi-core processor), multiple processors with a single core, multiple processors with multiples cores, or any combination thereof.

The memory/storage 530 can include a memory 532, such as a main memory, or other memory storage, and a storage unit 536, both accessible to the processors 510 such as via the bus 502. The storage unit 536 and memory 532 store the instructions 516 embodying any one or more of the methodologies or functions described herein. The instructions 516 can also reside, completely or partially, within the memory 532, within the storage unit 536, within at least one of the processors 510 (e.g., within the processor's cache memory), or any suitable combination thereof, during execution thereof by the machine 500. Accordingly, the memory 532, the storage unit 536, and the memory of the processors 510 are examples of machine-readable media.

As used herein, “machine-readable medium” means a device able to store instructions (e.g., instructions 516) and data temporarily or permanently and can include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 516. The term “machine-readable medium” shall also be taken to include any medium, or combination of multiple media, that is capable of storing instructions (e.g., instructions 516) for execution by a machine (e.g., machine 500), such that the instructions, when executed by one or more processors of the machine (e.g., processors 510), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 550 can include a wide variety of components to receive input, provide output, produce output, transmit information, exchange information, capture measurements, and so on. The specific I/O components 550 that are included in a particular machine will depend on the type of machine. For example, portable machines such as mobile phones will likely include a touch input device or other such input mechanisms, while a headless server machine will likely not include such a touch input device. It will be appreciated that the I/O components 550 can include many other components that are not shown in FIG. 5. The I/O components 550 are grouped according to functionality merely for simplifying the following discussion and the grouping is in no way limiting. In various example implementations, the I/O components 550 can include output components 552 and input components 554. The output components 552 can include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 554 can include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example implementations, the I/O components 550 can include biometric components 556, motion components 558, environmental components 560, or position components 562, among a wide array of other components. For example, the biometric components 556 can include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 558 can include acceleration sensor components (e.g., accelerometer), gravitation sensor components, rotation sensor components (e.g., gyroscope), and so forth. The environmental components 560 can include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that can provide indications, measurements, or signals corresponding to a surrounding physical environment. The position components 562 can include location sensor components (e.g., a Global Position System (GPS) receiver component), altitude sensor components (e.g., altimeters or barometers that detect air pressure from which altitude can be derived), orientation sensor components (e.g., magnetometers), and the like.

Communication can be implemented using a wide variety of technologies. The I/O components 550 can include communication components 564 operable to couple the machine 500 to a network 580 or devices 570 via a coupling 582 and a coupling 572, respectively. For example, the communication components 564 can include a network interface component or other suitable device to interface with the network 580. In further examples, the communication components 564 can include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 570 can be another machine or any of a wide variety of peripheral devices (e.g., a peripheral device coupled via a USB).

Moreover, the communication components 564 can detect identifiers or include components operable to detect identifiers. For example, the communication components 564 can include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information can be derived via the communication components 564, such as location via Internet Protocol (IP) geolocation, location via Wi-Fi® signal triangulation, location via detecting an NFC beacon signal that can indicate a particular location, and so forth.

In various example implementations, one or more portions of the network 580 can be an ad hoc network, an intranet, an extranet, a virtual private network (VPN), a local area network (LAN), a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 580 or a portion of the network 580 can include a wireless or cellular network and the coupling 582 can be a Code Division Multiple Access (CDMA) connection, a Global System for Mobile communications (GSM) connection, or another type of cellular or wireless coupling. In this example, the coupling 582 can implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 5G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 516 can be transmitted or received over the network 580 using a transmission medium via a network interface device (e.g., a network interface component included in the communication components 564) and utilizing any one of a number of well-known transfer protocols (e.g., HTTP). Similarly, the instructions 516 can be transmitted or received using a transmission medium via the coupling 572 (e.g., a peer-to-peer coupling) to the devices 570. The term “transmission medium” shall be taken to include any intangible medium that is capable of storing, encoding, or carrying the instructions 516 for execution by the machine 500, and includes digital or analog communications signals or other intangible media to facilitate communication of such software.

Throughout this specification, plural instances can implement components, operations, or structures described as a single instance. Although individual operations of one or more methods are illustrated and described as separate operations, one or more of the individual operations can be performed concurrently, and nothing requires that the operations be performed in the order illustrated. Structures and functionality presented as separate components in example configurations can be implemented as a combined structure or component. Similarly, structures and functionality presented as a single component can be implemented as separate components. These and other variations, modifications, additions, and improvements fall within the scope of the subject matter herein.

Although an overview of the inventive subject matter has been described with reference to specific example implementations, various modifications and changes can be made to these implementations without departing from the broader scope of implementations of the present disclosure. Such implementations of the inventive subject matter can be referred to herein, individually or collectively, by the term “invention” merely for convenience and without intending to voluntarily limit the scope of this application to any single disclosure or inventive concept if more than one is, in fact, disclosed.

The implementations illustrated herein are described in sufficient detail to enable those skilled in the art to practice the teachings disclosed. Other implementations can be used and derived therefrom, such that structural and logical substitutions and changes can be made without departing from the scope of this disclosure. The Detailed Description, therefore, is not to be taken in a limiting sense, and the scope of various implementations is defined only by the appended claims, along with the full range of equivalents to which such claims are entitled.

As used herein, the term “or” can be construed in either an inclusive or exclusive sense. Moreover, plural instances can be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and can fall within a scope of various implementations of the present disclosure. In general, structures and functionality presented as separate resources in the example configurations can be implemented as a combined structure or resource. Similarly, structures and functionality presented as a single resource can be implemented as separate resources. These and other variations, modifications, additions, and improvements fall within a scope of implementations of the present disclosure as represented by the appended claims. The specification and drawings are, accordingly, to be regarded in an illustrative rather than a restrictive sense.

What is claimed is:

1. A system comprising:
a processing device; and
a memory coupled to the processing device and storing instructions that, when executed by the processing device, cause the system to perform one or more operations comprising:
receiving a first transaction record generated by a first device with respect to a second device;
processing the received first transaction record in conjunction with a transaction execution application executing on the second device;
receiving one or more notifications corresponding to the processing of the first transaction record in conjunction with the second device; and
initiating, based on at least one of the one or more notifications, one or more operations with respect to the first device.

2. The system of claim 1, wherein the first transaction record comprises one or more parameters originating from the first device.

3. The system of claim 1, wherein receiving the first transaction record further comprises storing the first transaction record.

4. The system of claim 1, wherein processing the received first transaction record comprises parsing the first transaction record in relation to one or more aspects of a configuration of the second device.

5. The system of claim 1, wherein processing the received first transaction record further comprises initiating one or more operations based on aspects of the processing of the received first transaction record.

6. The system of claim 1, wherein processing the received first transaction record further comprises associating the first transaction record with a second notification.

7. The system of claim 1, wherein at least one of the one or more notifications corresponds to a routing of the first transaction record.

8. The system of claim 1, wherein at least one of the one or more notifications corresponds to an operation initiated with respect to the first transaction record.

9. The system of claim 1, wherein at least one of the one or more notifications comprises a selectable prompt.

10. The system of claim 1, wherein initiating one or more operations comprises initiating one or more operations further based on one or more inputs originating from one or more sensors.

11. The system of claim 1, wherein initiating one or more operations comprises initiating one or more operations further based on one or more inputs originating from one or more sensors of the first device.

12. The system of claim 1, wherein initiating one or more operations comprises initiating one or more operations further based on one or more inputs originating from one or more sensors of the second device.

13. The system of claim 1, wherein initiating one or more operations comprises initiating one or more operations further based on one or more inputs originating from one or more sensors of a third device.

14. A method comprising:
receiving a first transaction record generated by a first device with respect to a second device;
processing the received first transaction record in conjunction with a transaction execution application executing on the second device;
receiving one or more notifications corresponding to the processing of the first transaction record in conjunction with the second device; and
initiating, based on at least one of the one or more notifications, one or more operations with respect to the first device.

15. The system of claim 1, wherein processing the received first transaction record comprises parsing the first transaction record in relation to one or more aspects of a configuration of the second device.

16. The system of claim 1, wherein processing the received first transaction record further comprises associating the first transaction record with a second notification.

17. The system of claim 1, wherein at least one of the one or more notifications corresponds to an operation initiated with respect to the first transaction record.

18. The system of claim 1, wherein at least one of the one or more notifications comprises a selectable prompt.

19. The system of claim 1, wherein initiating one or more operations comprises initiating one or more operations further based on one or more inputs originating from one or more sensors of at least one of the first device or the second device.

20. A non-transitory computer readable medium having instructions stored thereon that, when executed by a processing device, cause the processing device to perform one or more operations comprising:
receiving a first transaction record generated by a first device with respect to a second device;
processing the received first transaction record in conjunction with a transaction execution application executing on the second device;
receiving one or more notifications corresponding to the processing of the first transaction record in conjunction with the second device; and
initiating, based on at least one of the one or more notifications and one or more inputs originating from one or more sensors of at least one of the first device or the second device, one or more operations with respect to the first device.
